(19) United States
(12) Patent Application Publication
(10) Pub. No.: US 2020/0273462 A1
(43) Pub. Date: Aug. 27, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Hideharu IWASHITA, Yokohama-shi (JP)

(73) Assignee: FUJI XEROX CO., LTD., Tokyo (JP)

(21) Appl. No.: 16/548,179

(22) Filed: Aug. 22, 2019

(30) Foreign Application Priority Data
Feb. 21, 2019 (JP) 2019-029284

(51) Int. Cl. G10L 15/26; G10L 15/08; G10L 15/22; G10L 15/30

(52) U.S. Cl. CPC G10L 15/26; G10L 15/30; G10L 15/22; G10L 15/08

(57) ABSTRACT

An information processing apparatus includes: a speech receiving unit that receives speech information that indicates input speech; a speech analysis unit that analyzes the received speech information to divide the speech information into certain units; and a guidance output unit that outputs, in the case where any of the units does not meet a predetermined condition, guidance information that provides guidance on input of speech information on the unit.

### CROSS-REFERENCE TO RELATED APPLICATIONS

This application is based on and claims priority under 35 USC 119 from Japanese Patent Application No. 2019-029284 filed Feb. 21, 2019.

### BACKGROUND

### (i) Technical Field

The present disclosure relates to an information processing apparatus and a non-transitory computer readable medium.

### (ii) Related Art

In recent years, there has been proposed an information processing apparatus that allows setting an item through speech input (see Japanese Unexamined Patent Application Publication No. 2007-127813, for example).

The information processing apparatus described in Japanese Unexamined Patent Application Publication No. 2007-127813 is a speech recognition device that enables setting through speech, and includes a receiving unit that receives a speech setting instruction, a speech analysis unit that recognizes and analyzes the content of the speech setting instruction to generate first structured data that include analysis result candidates, an instruction input detection unit that detects setting instruction input made by a user, an instruction input analysis unit that analyzes the content of the setting instruction input to generate second structured data, and a selection unit that selects one of the analysis result candidates included in the first structured data on the basis of the second structured data.

### SUMMARY

In the case where the content of the sequence input through speech is partly unclear, it is occasionally necessary to input all of the content of the sequence again.

Aspects of non-limiting embodiments of the present disclosure relate to providing an information processing apparatus and a non-transitory computer readable medium that enable executing an intended process, in the case where the content of a sequence input through speech is partly unclear, even without inputting all of the content of the sequence again.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a speech receiving unit that receives speech information that indicates input speech; a speech analysis unit that analyzes the received speech information to divide the speech information into certain units; and a guidance output unit that outputs, in a case where any of the units does not meet a predetermined condition, guidance information that provides guidance on input of speech information on the unit.

### BRIEF DESCRIPTION OF THE DRAWINGS

An exemplary embodiment of the present disclosure will be described in detail based on the following figures, wherein:

FIG. 1 is a block diagram illustrating an example of a control system of an information processing apparatus according to an exemplary embodiment of the present disclosure;

FIG. 2 is a schematic diagram illustrating an overview of an example of operation of the information processing apparatus illustrated in FIG. 1;

FIG. 3 is a flowchart illustrating an example of operation for a speech analysis process;

FIG. 4 is a flowchart illustrating an example of operation to provide guidance on re-input of an utterance;

FIG. 5 is a schematic diagram illustrating an overview of an example of operation of the information processing apparatus illustrated in FIG. 1;

FIG. 6 is a flowchart illustrating an example of operation for the speech analysis process;

FIG. 7 is a flowchart illustrating an example of operation to provide guidance on re-input of an utterance;

FIG. 8 is a schematic diagram illustrating an overview of an example of operation of the information processing apparatus illustrated in FIG. 1;

FIG. 9 is a flowchart illustrating an example of operation to provide guidance on re-input of an utterance; and

FIG. 10 is a block diagram illustrating an example of a control system of an information processing apparatus according to a modification.

### DETAILED DESCRIPTION

An exemplary embodiment of the present disclosure will be described below with reference to the drawings. In the drawings, constituent elements that have substantially the same function are denoted by the same reference numeral to omit redundant description. In the following, an image forming apparatus (specifically, a multi-function device) that has a plurality of functions such as a scan function, a printer function, a copy function, a facsimile function, and an electronic mail function, for example, is described as an example of an information processing apparatus. However, the information processing apparatus is not limited to a multi-function device.

### Exemplary Embodiment

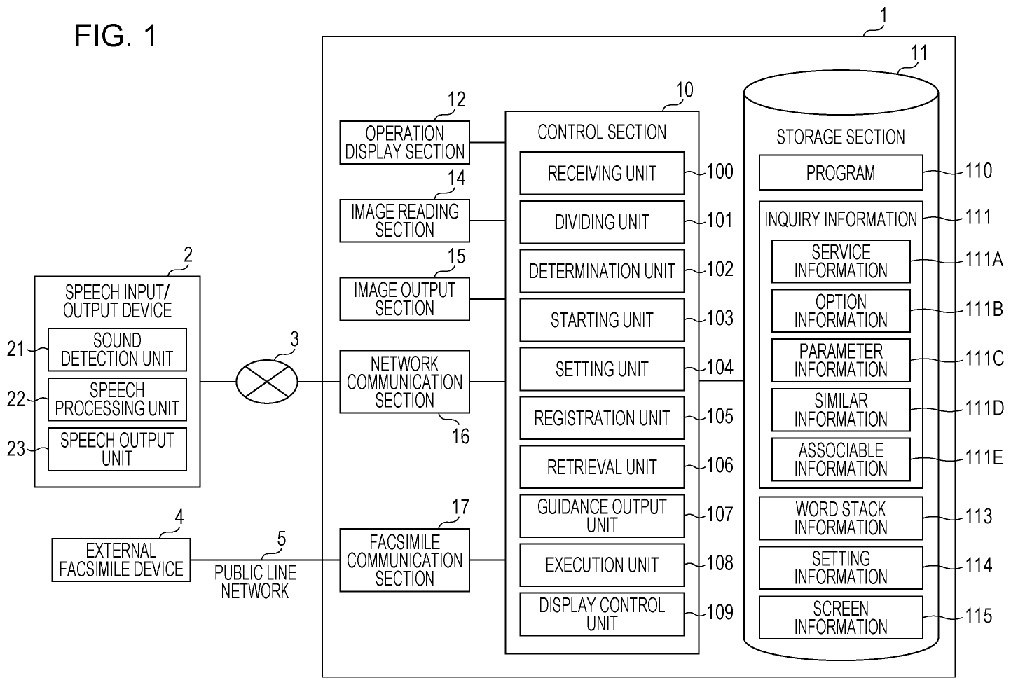

FIG. 1 is a block diagram illustrating an example of a control system of an information processing apparatus 1 according to an exemplary embodiment of the present disclosure. The information processing apparatus 1 includes a control section 10 that controls various sections, a storage section 11 that stores various types of data, an operation display section 12 that allows input and display of information, an image reading section 14 that reads a document image from a document, an image output section 15 that prints and outputs an image, a network communication section 16 that communicates with a speech input/output device 2 (to be discussed in detail later) via a network 3, and a facsimile communication section 17 that transmits and receives a facsimile to and from an external facsimile device 4 via a public line network 5. The information processing apparatus 1, the speech input/output device 2, the external facsimile device 4, the network 3, and the public line network 5 constitute an “information processing system”.

The control section 10 is composed of a central processing unit (CPU), an interface, etc. The CPU operates in accordance with a program 110 stored in the storage section 11 to function as a receiving unit 100, a dividing unit 101, a determination unit 102, a starting unit 103, a setting unit 104, a registration unit 105, a retrieval unit 106, a guidance output unit 107, an execution unit 108, a display control unit 109, etc. The receiving unit 100 is an example of a speech receiving unit. The units 100 to 109 will be discussed in detail later.

The storage section 11 is composed of a read only memory (ROM), a random access memory (RAM), a hard disk, etc., and stores various types of data such as the program 110, inquiry information 111, word stack information 113, setting information 114, and screen information 115. The inquiry information 111 is an example of a predetermined list.

The inquiry information 111 is information to be referenced in order to inquire, of instruction information input by an operator (hereinafter also referred to as a “user”), a function (hereinafter also referred to as a “service”) that is executable by the information processing apparatus 1 or an item (hereinafter also referred to as a “setting item” or an “option”) to be set in order to execute the service.

The inquiry information 111 includes, for example, service information 111A that includes a list of the names of services (hereinafter also referred to simply as “service names”) as an example of information that identifies services provided to the information processing apparatus 1, option information 111B that includes the names of options (hereinafter also referred to simply as “option names”), as an example of information that identifies options, in correlation with the service names, and parameter information 111C that includes information related to values (hereinafter also referred to as “set values” or “parameters”) that may be set for the options. The service information 111A and the option information 111B are an example of a first list.

The parameter information 111C includes parameters themselves that may be set for one setting item (e.g. for a setting item “color mode”, parameters such as “automatic” which allows automatically selecting monochrome or color in accordance with the state of a document, “monochrome” which indicates black-and-white printing, and “full color” which indicates printing in full color), and the types of the parameters (e.g. for a setting item “number of copies”, a natural number (number) in a certain range).

The service information 111A, the option information 111B, and the parameter information 111C may be stored in association with each other as in the following table, for example.

TABLE 1

| Service | Option | Parameter |
|---|---|---|
| information 111A | information 111B | information 111C |
| Copy | Number of copies | Number (natural number) |
| Copy | Color mode | Automatic/monochrome/full |
| | | color |
| . | . | . |
| . | . | . |
| . | . | . |

The inquiry information 111 may further include similar information 111D that includes words that are similar to the service names and the option names discussed above, and associable information 111E that includes words that are associable with the service names and the option names discussed above. Such similar words and associable words may be stored in association with the corresponding service names and option names.

The “similar” words have the same meaning as each other in spite of including different parts in names.

Specifically, the “similar” words have an index, indicating the degree of similarity to a service name or an option name, that is equal to or more than a certain value (hereinafter also referred to as a “first value”). By way of example, wording such as “color setting” is “similar” to the “color mode” as an option name.

The “associable” words have the same meaning as each other in spite of having different names. Specifically, the “associable” words have the above index, that is, an index indicating the degree of similarity to a service name or an option name, that is less than the first value and equal to or more than a second value. By way of example, wording such as “I would like to change the color” is “associable” with the “color mode” as an option name, and wording such as “print” is “associable” with the “copy” as an option name.

Words that are similar to a service name and words that are similar to an option name are examples of a first word. The similar information 111D is an example of a second list. Words that are associable with a service name and words that are associable with an option name are examples of a second word. The associable information 111E is an example of a third list.

The word stack information 113 is information in which character strings that constitute a sentence to be discussed later are temporarily registered. The setting information 114 is information that includes set parameters, and information to be referenced when the execution unit 108 to be discussed later executes a service.

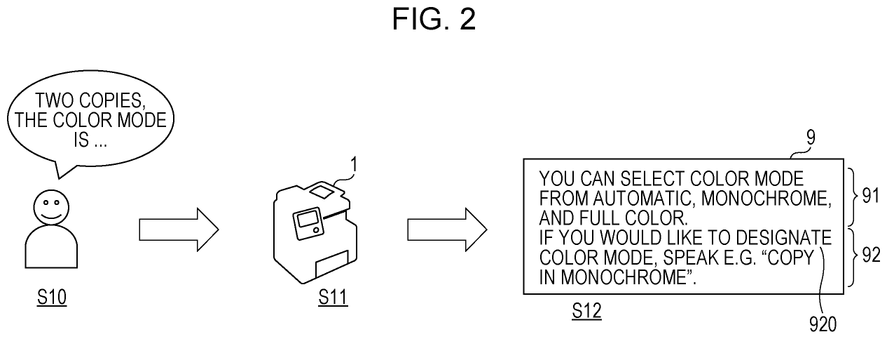

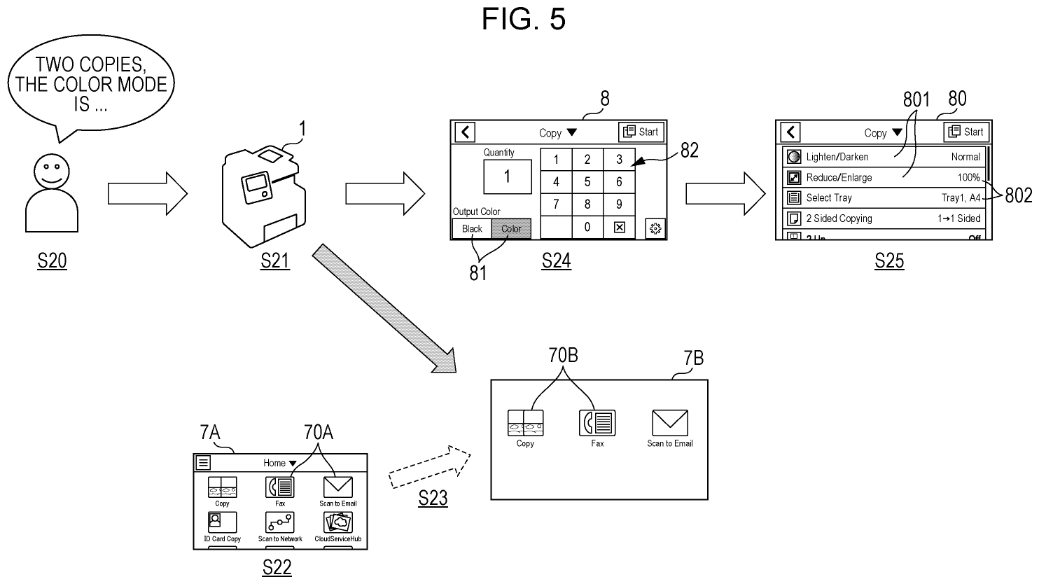

The screen information 115 is information on various types of screens to be displayed on a display surface (not illustrated) of the operation display section 12 by the display control unit 109 to be discussed later. Examples of the screens include a guidance screen 9 (see FIG. 2), home screens 7A and 7B (see FIG. 5), and a setting screen 8 (see FIG. 5).

The operation display section 12 is a touch-screen display, for example, and includes a display such as a liquid crystal display and a touch screen superposed thereon. The image reading section 14 reads a document image from a document, and includes a document platen (not illustrated), an automatic document feeding device (not illustrated) provided thereon, and a scanner. The image reading section 14 optically reads a document image from a document disposed on the document platen or fed by the automatic document feeding device (not illustrated).

The image output section 15 prints and outputs a color image or a monochrome image on a recording medium such as paper through an electrophotographic system, an inkjet system, etc. The network communication section 16 is implemented by a network interface card (NIC) etc., and transmits and receives a signal to and from an external device via the network 3.

The facsimile communication section 17 modulates and demodulates data in accordance with a facsimile protocol such as G3 or G4, and performs facsimile communication via the public line network 5.

Next, various units that constitute the control section 10 will be described in detail. The receiving unit 100 receives information (hereinafter also referred to simply as “speech information”) related to speech input from the speech input/output device 2. The speech information includes instruction information that provides an instruction for execution of a function, etc.

The dividing unit 101 analyzes the speech information to divide the content of the sequence included in the speech information into segments (hereinafter also referred to as “sentences”). The sentences are partial elements that constitute the content of the sequence, and refer to certain units that have particular meanings.

Examples of the sentences include phrases separated to a certain length so as to include a principal element such as a word and a morpheme and the preceding or following element such as a preposition and an adverb. The content of the sequence may be given in a format structured as a sentence, or may be given in a format structured as a list of articles each including a principal element such as a service name, an option name, and a parameter extracted from a sentence, for example.

The determination unit 102 determines whether or not each of the sentences meets a predetermined condition. Specifically, the determination unit 102 determines whether or not the sentence is included in the inquiry information 111. More specifically, the determination unit 102 determines whether or not there is any word, among the words included in the inquiry information 111, that coincides with a particular word included in character strings that constitute the sentence.

The starting unit 103 starts the various types of services such as scan, printer, copy, facsimile, and electronic mail discussed above. The setting unit 104 sets parameters that are necessary to execute the services.

Specifically, the setting unit 104 stores parameters in the setting information 114 in the storage section 11.

The registration unit 105 registers the character strings that constitute the sentence in the word stack information 113. The retrieval unit 106 retrieves a word stored in the word stack information 113, and deletes the retrieved word from the word stack information 113.

The guidance output unit 107 outputs guidance information that prompts the user to input again speech information related to a sentence that does not meet the predetermined condition discussed above. The guidance output unit 107 may output the guidance information through speech, or may output the guidance information on a screen or using characters.

In the case where the guidance information is output through speech, the guidance output unit 107 transmits speech information to be output to the speech input/output device 2 via the network 3. In the case where the guidance information is output on a screen or using characters, the display control unit 109 to be discussed later is instructed to display the guidance information.

The execution unit 108 executes the various types of services by controlling the image reading section 14, the image output section 15, the facsimile communication section 17, etc. The display control unit 109 performs control so as to display a screen on the display surface of the operation display section 12.

(Configuration of Speech Input/Output Device 2)

The speech input/output device 2 is used to input and output speech. The speech input/output device 2 is a smart speaker, for example. The speech input/output device 2 includes a sound detection unit 21 that detects an input sound, a speech processing unit 22 that extracts speech information by processing information on the detected sound, and a speech output unit 23 that outputs speech. The speech input/output device 2 may include a speech input device and a speech output device provided separately from each other.

(Network 3)

Examples of the network 3 include a local area network (LAN), a wide area network (WAN), the Internet, an intranet, etc. The network 5 may be either wired or wireless.

(Operation According to Exemplary Embodiment)

Next, operation of the image processing apparatus 1 according to the present exemplary embodiment will be described. In the following description, the following three instances will be described as examples.

(1) A case where a speech instruction related to a parameter is unclear;

(2) A case where a speech instruction for a service or an option is unclear; and

(3) A modification of (1) and (2) above.

The language “a speech instruction is unclear” means that the content of an utterance by the user is not recognized by the information processing apparatus 1. Examples of the case where “a speech instruction is unclear” include a case where all or a part of an utterance is not detected by the speech input/output device 2, and a case where an utterance itself is detected but the content of the utterance may not be analyzed (e.g. a case where a word that constitutes the utterance is not included in predetermined dictionary information). In the following, instruction information is described as being input through speech. However, instruction information may be input by a method other than speech, such as using characters input using a keyboard, for example.

(1) Case where Speech Instruction Related to Parameter is Unclear

FIG. 2 is a schematic diagram illustrating an overview of an example of operation of the information processing apparatus 1 illustrated in FIG. 1. By way of example, a scene in which an instruction for execution of the copy function, which is one of the services, is provided will be described as an example below. Specifically, a case where an instruction is input from the user through an utterance “Two copies, the color mode is . . . ” will be described as an example. “ . . . ” indicates that the content of the utterance is unclear. “ . . . ” has the same meaning when used below.

As illustrated in FIG. 2, when the user inputs instruction information to the information processing apparatus 1 through speech (S10), the sound detection unit 21 of the speech input/output device 2 which is connected to the information processing apparatus 1 detects the speech, and the speech processing unit 22 processes the detected speech to transmit speech information to the information processing apparatus 1. The information processing apparatus 1 receives the speech information (S11).

The information processing apparatus 1 analyzes the received speech information to extract the content of an instruction included in the speech information, and starts a service, sets a parameter for an option, and executes the service in accordance with the instruction. Specifically, the starting unit 103 starts a service, the setting unit 104 sets a parameter, and the execution unit 108 executes the service in accordance with an instruction included in the speech information.

At this time, in the case where a parameter may not be set for an option since an unclear content is included in the analyzed speech information, the information processing apparatus 1 outputs the guidance screen 9 (S12).

The guidance screen 9 is a screen that notifies the user that an unclear content is included in at least a part of the input speech information, and that prompts the user to input the unclear content again. The guidance screen 9 includes a first message 91 that indicates parameters that may be input, that is, parameters that may be received by the information processing apparatus 1, and a second message 92 that includes an example sentence 920 that prompts the user to make the utterance again in order to input (hereinafter also referred to simply as “re-input”) the speech again and that indicates a specific example of input. The guidance screen 9 is an example of guidance information.

When the user re-inputs the unclear content, the information processing apparatus 1 analyzes the re-input speech information, starts a service, sets a parameter for an option, and executes the service (S11).

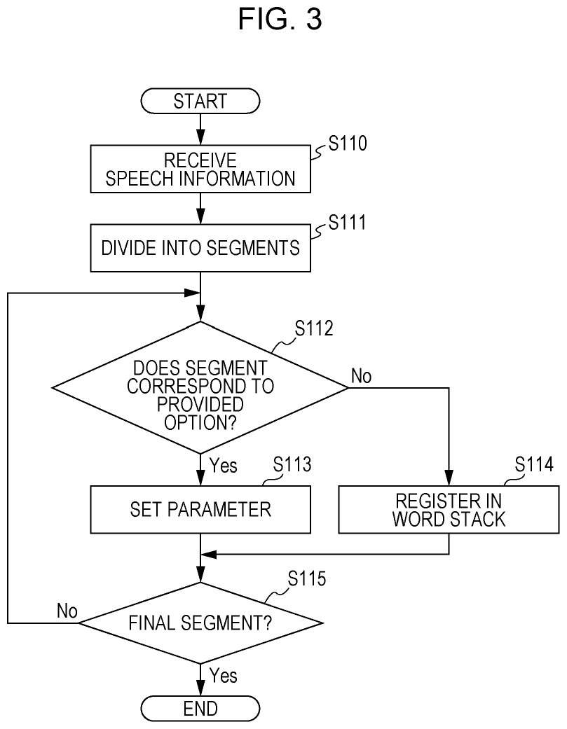

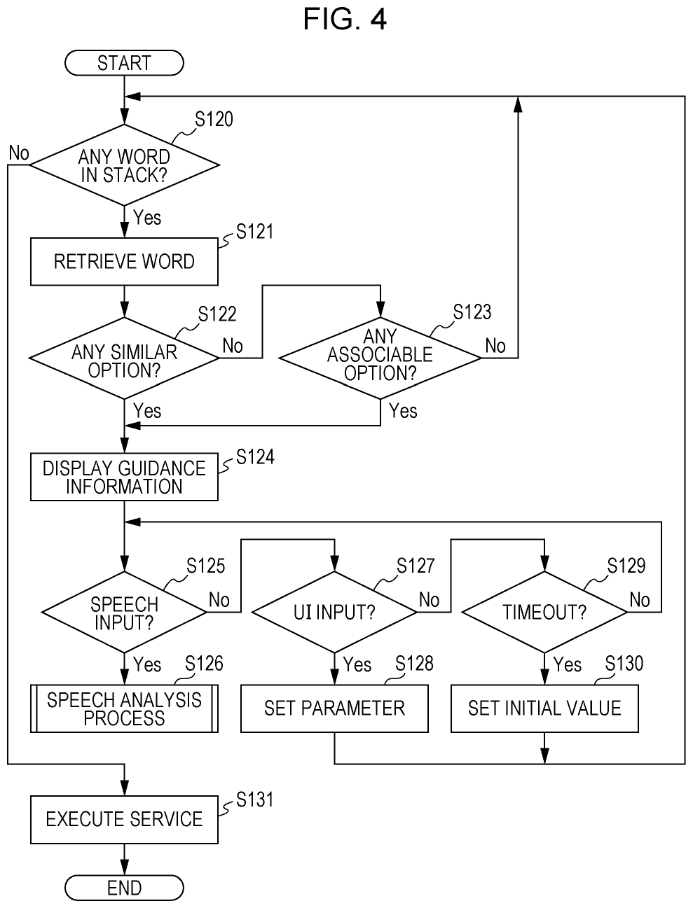

Next, the operation illustrated in FIG. 2 will be specifically described with reference to FIGS. 3 and 4. In the following, the operation will be described separately as (1-1) operation to analyze an utterance and set a parameter (hereinafter also referred to collectively as a “speech analysis process”) and (1-2) operation to provide guidance on re-input of a parameter. For convenience of description, a process performed by the speech input/output device 2 discussed above will not be described in detail below. This instance is described on the assumption that a service is started appropriately as instructed through speech.

(1-1) Operation for Speech Analysis Process

FIG. 3 is a flowchart illustrating an example of operation for the speech analysis process. As illustrated in FIG. 3, the receiving unit 100 of the information processing apparatus 1 receives speech information transmitted from the speech input/output device 2 (S110).

Next, the dividing unit 101 analyzes the speech information to divide the speech information into segments (i.e. sentences) (S111). By way of example, in the case of the utterance discussed above, the dividing unit 101 divides the utterance “Two copies, the color mode is . . . ” into a first sentence “Two copies” and a second sentence “the color mode is . . . ”.

The determination unit 102 determines whether or not the sentence corresponds to an option (hereinafter also referred to simply as a “provided option”) provided by the information processing apparatus 1 (S112). Specifically, the determination unit 102 checks the sentence with the inquiry information 111 which is stored in the storage section 11 to determine whether or not character strings that constitute the sentence include a word included in the option information 111B or the parameter information 111C of the inquiry information 111.

In the case where the sentence corresponds to a provided option (S112: Yes), the setting unit 104 sets a parameter (S113). By way of example, the setting unit 104 sets a value “2” to “number of copies”, which is an item for the copy function, in accordance with the first sentence “Two copies”.

In the case where the sentence does not correspond to a provided option (S112: No), the registration unit 105 registers the character strings which constitute the sentences in the word stack information 113 (S114). In the example discussed above, by way of example, the registration unit 105 registers the character string of the second sentence “the color mode is . . . ” in the word stack information 113.

The steps (steps S112 to S114) discussed above in which the sentences are checked with the inquiry information 111 and a parameter is extracted and set are executed sequentially for each of the segments from the first to the last segment (of the second sentence in the example discussed above) (S115).

(1-2) Operation to Provide Guidance on Re-Input of Parameter

FIG. 4 is a flowchart illustrating an example of operation to provide guidance on re-input of an utterance. As illustrated in FIG. 4, in the case where any word is included, that is, there is any word, in the word stack information 113 (hereinafter also referred to simply as a “stack 113”) (S120: Yes), the retrieval unit 106 retrieves the word from the stack 113 (S121), and deletes the retrieved word from the stack 113.

The determination unit 102 checks the retrieved word with the similar information 111D which is stored in the storage section 11, and determines whether or not there is any option that is similar to the retrieved word (S122). Specifically, the determination unit 102 determines whether or not any word that is similar to an option name is included in the retrieved word.

In the case where there is any similar option (S122: Yes), the guidance output unit 107 outputs guidance information (S124). Specifically, as discussed above, the guidance output unit 107 outputs the guidance screen 9 on the display surface of the operation display section 12. The guidance output unit 107 may output guidance information through speech.

In the case where there is no similar option (S122: No), the determination unit 102 checks the retrieved word with the associable information 111E which is stored in the storage section 11, and determines whether or not there is any option that is associable with the retrieved word (S123). Specifically, the determination unit 102 determines whether or not any word that is associable with an option name is included in the retrieved word.

In the case where there is any associable option (S123: Yes), the guidance output unit 107 outputs guidance information (S124). In the case where there is no associable option (S123: No), the operation in steps S121 to S124 is executed for the next word registered in the stack 113. The operation in steps S121 to S124 is executed while words are registered in the stack 113, sequentially in the order of registration.

In the case where a parameter is input through speech by the user (hereinafter also referred to simply as “speech input”; S125: Yes) in response to the guidance information, the speech analysis process described in relation to FIG. 3 is executed (S126). In the case where a parameter is input using an operation section of the operation display section 12 (hereinafter also referred to simply as “UI input”; S127: Yes), the setting unit 104 sets the input parameter (S128).

In the case where neither speech input nor UI input is made for a certain time, that is, a timeout occurs (S129: Yes), the setting unit 104 sets an initial value, that is, a predetermined parameter (S130). In such a case, the setting unit 104 impartially sets the “color mode” to “monochrome”, for example. The execution unit 108 executes the service using the set parameter (8131).

(2) Case where Speech Instruction Related to Service or Option is Unclear

FIG. 5 is a schematic diagram illustrating an overview of an example of operation of the information processing apparatus 1 illustrated in FIG. 1. As illustrated in FIG. 5, steps S20 and S21 operate similarly to steps S10 and S11, respectively, illustrated in FIG. 2 and discussed above. That is, when the user inputs instruction information to the information processing apparatus 1 through speech (820), the information processing apparatus 1 receives speech information (S21).

The display control unit 109 performs control so as to display the home screen 7A on the display surface of the operation display section 12 (S22). The home screen 7A includes icons 70A for starting services. The “icons” are each a figure that represents a function. However, the “icons” may each include a character or a symbol, and may each be constituted of a character or a symbol alone. The icons are examples of an operator.

The starting unit 103 starts a service in accordance with information that provides an instruction for starting a service included in the speech information. At this time, in the case where the service name is unclear, the service is not started. In this case, the display control unit 109 performs control so as to display the home screen 7B by changing the icons 70A (S23). Specifically, the display control unit 109 extracts services that are selectable in accordance with speech input, and performs control so as to display the home screen 7B which includes icons 70B related to the extracted services.

In the case where a service is started by the starting unit 103, the display control unit 109 performs control so as to display, on the display surface of the operation display section 12, the setting screen 8 which allows setting for options (S24).

By way of example, FIG. 5 illustrates a screen for various types of setting for copy. The setting screen 8 includes, for example, color mode select buttons 81 for setting the “color mode”, numeric keys 82 for designating the number of copies, etc.

In the case where there are no corresponding options, the display control unit 109 performs control so as to display a list screen 80 that indicates a list of options (S25). The list screen 80 includes display fields that each display a first character string 801, which indicates the name of an option corresponding to the started service, and a second character string 802, which indicates a parameter set for each option, in correlation with each other.

The display control unit 109 may perform control so as to display the option names as arranged in accordance with a predetermined order of priority. For example, the display control unit 109 may perform control so as to display the option names as arranged in accordance with frequency information that indicates the frequency at which an item is set, probability information that indicates the possibility of setting (e.g. in the case where the speech information includes a number, items for which the number may be set), etc.

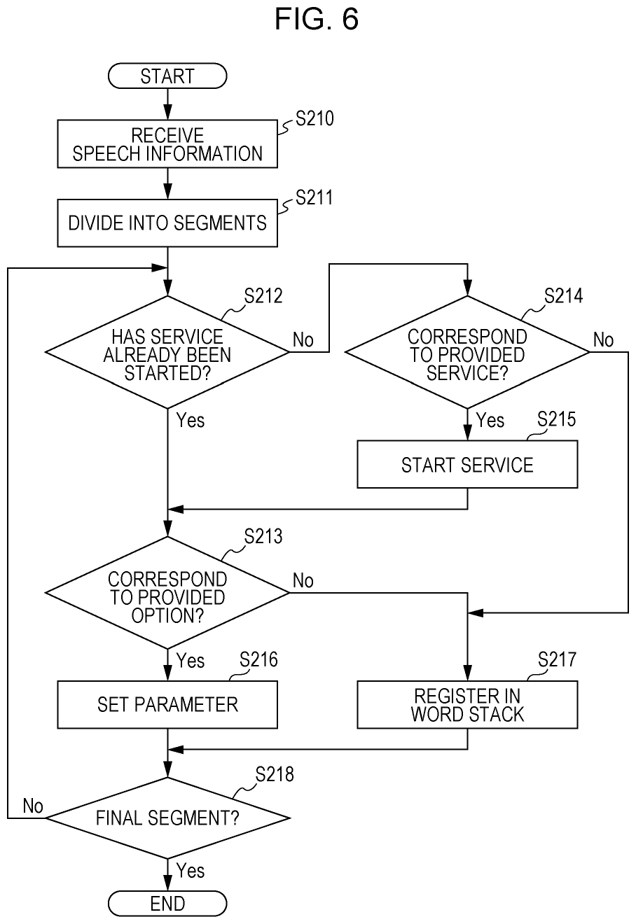

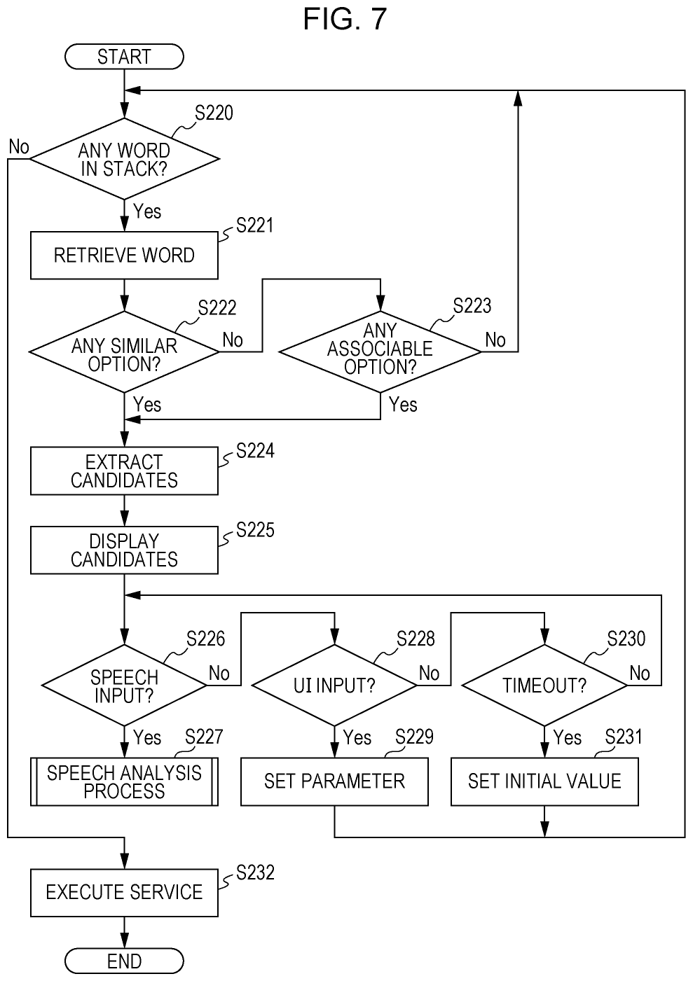

Next, the operation illustrated in FIG. 5 will be specifically described with reference to FIGS. 6 and 7, separately as (2-1) the speech analysis process and (2-2) operation to prompt re-input of a service or an option. Operation that is substantially the same as the operation described in relation to FIGS. 3 and 4 and discussed above will not be described in detail but be described only briefly.

(2-1) Speech Analysis Process

FIG. 6 is a flowchart illustrating an example of operation for the speech analysis process. As illustrated in FIG. 6, the receiving unit 100 receives speech information transmitted from the speech input/output device 2 (S210), and the dividing unit 101 analyzes the speech information to divide the speech information into segments (S211).

In the case where a particular service has already been started (S212: Yes), the determination unit 102 determines whether or not the sentence corresponds to a provided option (S213).

In the case where the sentence corresponds to a provided option (S213: Yes), the setting unit 104 sets a parameter (S216). In the case where the sentence does not correspond to a provided option (S213: No), the registration unit 105 registers the sentence in the word stack information 113 as a word (S217).

In the case where a particular service has not been started yet (S212: No), the determination unit 102 determines whether or not the sentence corresponds to a service (hereinafter also referred to simply as a “provided service”) provided by the information processing apparatus 1 (S214). The provided service is, in other words, a function provided to the information processing apparatus 1.

Specifically, the determination unit 102 check the sentence with the inquiry information 111 which is stored in the storage section 11 to determine whether or not the sentence is included in the service information 111A of the inquiry information 111.

In the case where the sentence corresponds to a provided service (S214: Yes), the starting unit 103 starts the service (S215). In the case where the sentence does not correspond to a provided service (S214: No), the registration unit 105 registers the sentence in the word stack information 113 as a word (S217). Such steps (steps S212 to S217) are executed sequentially for each of the segments from the first to the last segment (S218).

(2-2) Operation to Provide Guidance on Re-Input of Service or Option

FIG. 7 is a flowchart illustrating an example of operation to provide guidance on re-input of an utterance. As illustrated in FIG. 7, in the case where there is any word in the stack 113 (S220: Yes), the retrieval unit 106 retrieves the word from the stack 113 (S221), and deletes the word from the stack 113.

The determination unit 102 checks the retrieved word with the similar information 111D which is stored in the storage section 11, and determines whether or not there is any service or option that is similar to the retrieved word (S222).

In the case where there is any similar service or similar option (S222: Yes), the display control unit 109 extracts candidates for the service or the option (S224), and performs control so as to display the extracted candidates (S225).

In the case where there is no similar service or option (S222: No), the determination unit 102 checks the retrieved word with the associable information 111E which is stored in the storage section 11, and determines whether or not there is any service or option that is associable with the retrieved word (S223).

In the case where there is any associable service or associable option (S223: Yes), the display control unit 109 extracts candidates for the service or the option (S224), and performs control so as to display the extracted candidates (S225).

In the case where there is no associable option (S223: No), the operation in steps S221 to S225 is executed for the next word registered in the stack 113. The operation in steps S221 to S225 is executed while words are registered in the stack 113, sequentially in the order of registration.

Thereafter, steps S226 to S232 operate similarly to steps S125 to S131, respectively, discussed above. That is, in the case where a parameter is input through speech by the user in response to the guidance information (S226: Yes), the speech analysis process described in relation to FIG. 6 is executed (S227). In the case where a parameter is input through UI (S228: Yes), the setting unit 104 sets the input parameter (S229).

In the case where neither speech input nor UI input is made for a certain time (S230: Yes), the setting unit 104 sets a predetermined parameter (S231). The execution unit 108 executes the service using the set parameter (S232).

(3) Case where Speech Instruction Related to Parameter is Unclear

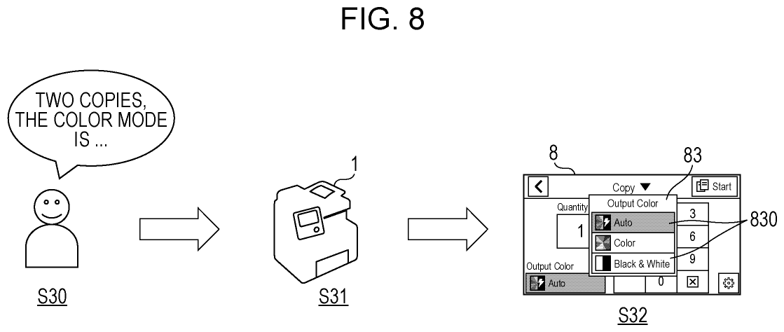

FIG. 8 is a schematic diagram illustrating an overview of an example of operation of the information processing apparatus 1 illustrated in FIG. 1. As illustrated in FIG. 8, steps S30 and S31 operate similarly to steps S10 and S11, respectively, illustrated in FIG. 2 and discussed above. That is, when the user inputs instruction information to the information processing apparatus 1 through speech (S30), the information processing apparatus 1 receives speech information (S31).

In the case where information that indicates start of a service and information that designates an option, among information included in the speech information, are recognized appropriately and only information that designates a parameter is unclear, the display control unit 109 may perform control so as to display a select screen 83 that allows selecting a parameter together with the setting screen 8 (S32). The select screen 83 displays a list of third character strings 830 that indicate parameters that may be set. As illustrated in FIG. 8, the select screen 83 may be displayed as a pop-up on the setting screen 8.

(3-1) Speech Analysis Process

The speech analysis process is similar to the steps illustrated in FIG. 6 and discussed above, and therefore is not described.

(3-2) Operation to Provide Guidance on Re-Input of Parameter

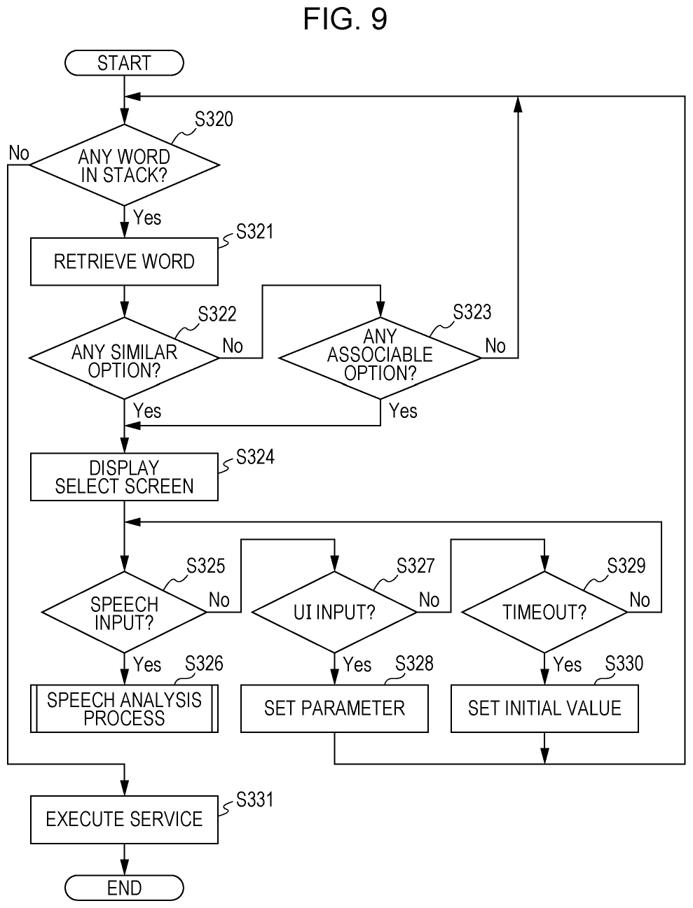

FIG. 9 is a flowchart illustrating an example of operation to provide guidance on re-input of an utterance. As illustrated in FIG. 9, in the case where there is any word in the stack 113 (S320: Yes), the retrieval unit 106 retrieves the word from the stack 113 (S321), and deletes the word from the stack 113.

The determination unit 102 checks the retrieved word with the similar information 111D which is stored in the storage section 11, and determines whether or not there is any option that is similar to the retrieved word (S322).

In the case where there is any similar option (S322: Yes), the display control unit 109 performs control so as to display the select screen 83 (S324).

In the case where there is no similar option (s322: No), the determination unit 102 checks the retrieved word with the associable information 111E which is stored in the storage section 11, and determines whether or not there is any option that is associable with the retrieved word (S323).

In the case where there is any associable option (S323: Yes), the display control unit 109 performs control so as to display the select screen 83 (S225).

In the case where there is no associable option (S323: No), the operation in steps S321 to S324 is executed for the next word registered in the stack 113. The operation in steps S321 to S324 is executed while words are registered in the stack 113, sequentially for each of the words.

Thereafter, steps S325 to S331 operate similarly to steps S125 to S131, respectively, discussed above. That is, in the case where a parameter is input through speech by the user in response to the guidance information (S325: Yes), the speech analysis process described in relation to FIG. 6 is executed (8326). In the case where a parameter is input through UI (S327: Yes), the setting unit 104 sets the input parameter (s328).

In the case where neither speech input nor UI input is made for a certain time (S329: Yes), the setting unit 104 sets a predetermined parameter (S330). The execution unit 108 executes the service using the set parameter (S331).

<Modifications>

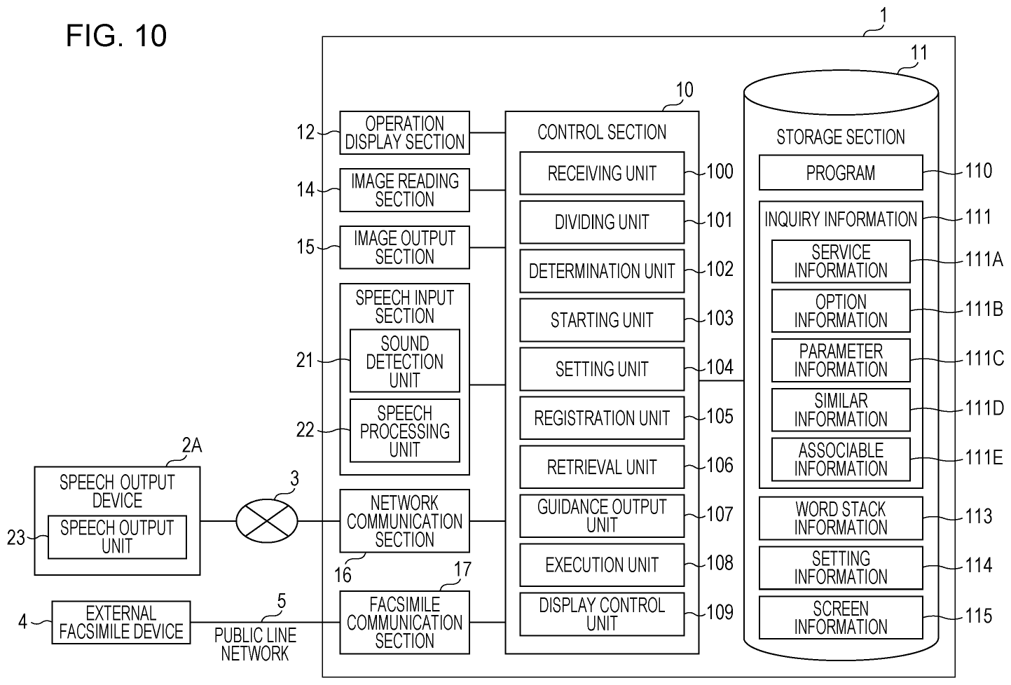

FIG. 10 is a block diagram illustrating an example of a control system of an information processing apparatus according to a modification. As illustrated in FIG. 10, the speech input/output device 2 may be provided separately as a speech input section 18 that allows input of speech and a speech output device 2A that outputs speech. Examples of such a speech input section 18 include a built-in microphone. Examples of the speech output device 2A include a speaker.

In the case of such a configuration, the speech input section 18 may be provided inside the information processing apparatus 1. The speech processing unit 22 may be provided in the control section 10 of the information processing apparatus 1.

While an exemplary embodiment of the present disclosure has been described above, exemplary embodiments of the present disclosure are not limited to the exemplary embodiment described above, and a variety of modifications and implementations may be made without departing from the scope and spirit of the present disclosure. For example, in the exemplary embodiment discussed above, the sentence itself is stored in the word stack information 113. However, the present disclosure is not limited to this aspect. A principal word may be extracted from the sentence, and only the extracted word may be stored in the word stack information 113.

The various units of the control section 10 may be partially or wholly constituted of a hardware circuit such as a Field Programmable Gate Array (FPGA), an Application Specific Integrated Circuit (ASIC), etc.

Some of the constituent elements of the exemplary embodiment described above may be omitted or changed without departing from the scope and spirit of the present disclosure. Additions, deletions, changes, interchanges, etc. may be made to the steps of the flow according to the exemplary embodiment described above without departing from the scope and spirit of the present disclosure. The program used in the exemplary embodiment described above may be provided as recorded in a computer-readable recording medium such as a CD-ROM, or may be stored in an external server such as a cloud server to be used via a network.

What is claimed is:

1. An information processing apparatus comprising:
a speech receiving unit that receives speech information that indicates input speech;
a speech analysis unit that analyzes the received speech information to divide the speech information into certain units; and
a guidance output unit that outputs, in a case where any of the units does not meet a predetermined condition, guidance information that provides guidance on input of speech information on the unit.

2. The information processing apparatus according to claim 1,
wherein the guidance output unit outputs the guidance information when a particular word included in the unit is not included in a predetermined list.

3. The information processing apparatus according to claim 2, further comprising
a registration unit that temporarily registers the unit which includes the particular words in a storage section in a case where the particular word is not included in the predetermined list.

4. The information processing apparatus according to claim 3,
wherein, in a case where the list is defined as a first list, there are further provided
a second list that includes the particular word and a first word, whose index that indicates a degree of similarity to the particular word is equal to or more than a first value, and
a third list that includes the first word and a second word, whose index that indicates the degree of similarity to the particular word is less than the first value and equal to or more than a second value, and
the guidance output unit outputs the guidance information in a case where the particular word included in the unit registered in the storage section is not included in either the second list or the third list.

5. The information processing apparatus according to claim 2, further comprising
a display control unit that performs control so as to display the predetermined list in a case where the unit does not meet the predetermined condition.

6. The information processing apparatus according to claim 5,
wherein the display control unit performs control so as to display the predetermined list in accordance with a predetermined order of priority.

7. The information processing apparatus according to claim 5,
wherein the display control unit performs control so as to select and display an operator that starts a function provided to the apparatus in accordance with a predetermined rule in a case where the unit does not meet the predetermined condition.

8. A non-transitory computer readable medium storing a program causing a computer to execute a process, the process comprising:
receiving input speech information;
analyzing the received speech information to divide the speech information into certain units; and
in a case where any of the units does not meet a predetermined condition, outputting guidance information that provides guidance on input of speech information on the unit.

9. An information processing apparatus comprising:
speech receiving means for receiving speech information that indicates input speech;
speech analysis means for analyzing the received speech information to divide the speech information into certain units; and
guidance output means for outputting, in a case where any of the units does not meet a predetermined condition, guidance information that provides guidance on input of speech information on the unit.
